(19) United States
(12) Patent Application Publication
(10) Pub. No.: US 2010/0097401 A1
(43) Pub. Date: Apr. 22, 2010

(54) IMAGE PROCESSING DEVICE, PROGRAM, AND RECORDING MEDIUM

(75) Inventor: Fumiyuki SHIRATANI, Sagamihara-shi (JP)

Correspondence Address: SCULLY SCOTT MURPHY & PRESSER, PC, 400 GARDEN CITY PLAZA, SUITE 300, GARDEN CITY, NY, 11530, US

(73) Assignees: OLYMPUS CORPORATION, Tokyo (JP); OLYMPUS IMAGING CORP., Tokyo (JP)

(21) Appl. No.: 12/643,247

(22) Filed: Dec. 21, 2009

Related U.S. Application Data
(63) Continuation of application No. PCT/JP08/60286, filed on Jun. 4, 2008.

(30) Foreign Application Priority Data
Jun. 27, 2007 (JP) P2007-164984

(51) Int. Cl. G09G 5/00

(52) U.S. Cl. 345/660

(57) ABSTRACT

An image processing device includes an image input section receiving the input of an image, an image converter generating a converted image by magnifying or reducing the image, the input of which is received by the image input section, based on a predetermined conversion magnification, a small moving object probe specifying a small moving object area, which is an image area including a small moving object, in the image, the input of which is received by the image input section, a small moving object area converter generating a magnified image of the small moving object by magnifying the small moving object area, which is specified by the small moving object probe, and an image generator generating a synthetic image by synthesizing the magnified image of the small moving object generated by the small moving object area converter with the converted image generated by the image converter.

### CROSS-REFERENCE TO RELATED APPLICATION

This application is a continuation application based on a PCT Patent Application No. PCT/JP2008/060286, filed Jun. 4, 2008, whose priority is claimed on Japanese Patent Application No. 2007-164984, filed Jun. 22, 2007. The contents of both the PCT Application and the Japanese Application are incorporated herein by reference.

### BACKGROUND OF THE INVENTION

1. Field of the Invention

The present invention relates to an image processing device that can process an image of a small moving object, a program that controls an operation of the image processing device, and a recording medium that records the program.

2. Description of Related Art

In the related art, as a method for displaying a moving image, there is known a display method for magnifying a specific area while reducing its surroundings, (see, for example, Japanese Unexamined Patent Application, First Publication No. H07-334665). In addition, there is known a method for zooming in and imaging a designated area of interest, and synthesizing the zoomed and imaged area of interest with the entire image (see, for example, Japanese Unexamined Patent Application, First Publication No. 2003-348431). Furthermore, there is known a method, which recognizes a position for attention by performing a frequency analysis of a moving image, determines an area to be magnified, and magnifies and displays the determined area (see, for example, Japanese Unexamined Patent Application, First Publication No. 2005-292691).

### SUMMARY OF THE INVENTION

An image processing device according to an aspect of the present invention includes: an image input section which receives an input of an image; an image converter which generates a converted image by magnifying or reducing the image, the input of which is received by the image input section, based on a predetermined conversion magnification; a small moving object probe which specifies a small moving object area in the image, the input of which is received by the image input section, the small moving object area being an image area including a small moving object; a small moving object area converter which generates a magnified image of the small moving object by magnifying the small moving object area, which is specified by the small moving object probe; and an image generator which generates a synthetic image by synthesizing the magnified image of the small moving object generated by the small moving object area converter with the converted image generated by the image converter.

A program according to an aspect of the present invention is a program that controls an operation of an image processing device, the program causing the image processing device to execute: a step of receiving an input of an image; a step of generating a converted image by magnifying or reducing the image based on a predetermined conversion magnification; a step of specifying a small moving object area in the image, the small moving object area being an image area including a small moving object; a step of generating a magnified image of the small moving object by magnifying the specified small moving object area; and a step of generating a synthetic image by synthesizing the magnified image of the small moving object with the converted image.

A recording medium according to an aspect of the present invention records a program that controls an operation of an image processing device, the program causing the image processing device to execute: a step of receiving an input of an image; a step of generating a converted image by magnifying or reducing the image based on a predetermined conversion magnification; a step of specifying a small moving object area in the image, the small moving object area being an image area including a small moving object; a step of generating a magnified image of the small moving object by magnifying the specified small moving object area; and a step of generating a synthetic image by synthesizing the magnified image of the small moving object with the converted image.

### BRIEF DESCRIPTION OF THE DRAWINGS

FIG. 1 is a configuration view showing the structure of an image processing device according to a first embodiment of the present invention.

FIG. 2 is a configuration view showing the structure of a TV set using the image processing device according to the first embodiment of the present invention.

FIG. 3 is a configuration view showing the structure of a video camera using the image processing device according to the first embodiment of the present invention.

FIG. 4 is a view showing the flow of a process according to the first embodiment of the present invention.

FIG. 5 is a configuration view showing the structure of an image processing device according to a second embodiment of the present invention.

FIG. 6 is a configuration view showing the structure of a TV set using the structure of the image processing device according to the second embodiment of the present invention.

FIG. 7 is a configuration view showing the structure of a video camera using the structure of the image processing device according to the second embodiment of the present invention.

FIG. 8 is a view showing the flow of a process according to the second embodiment of the present invention.

### DETAILED DESCRIPTION OF THE INVENTION

### First Embodiment

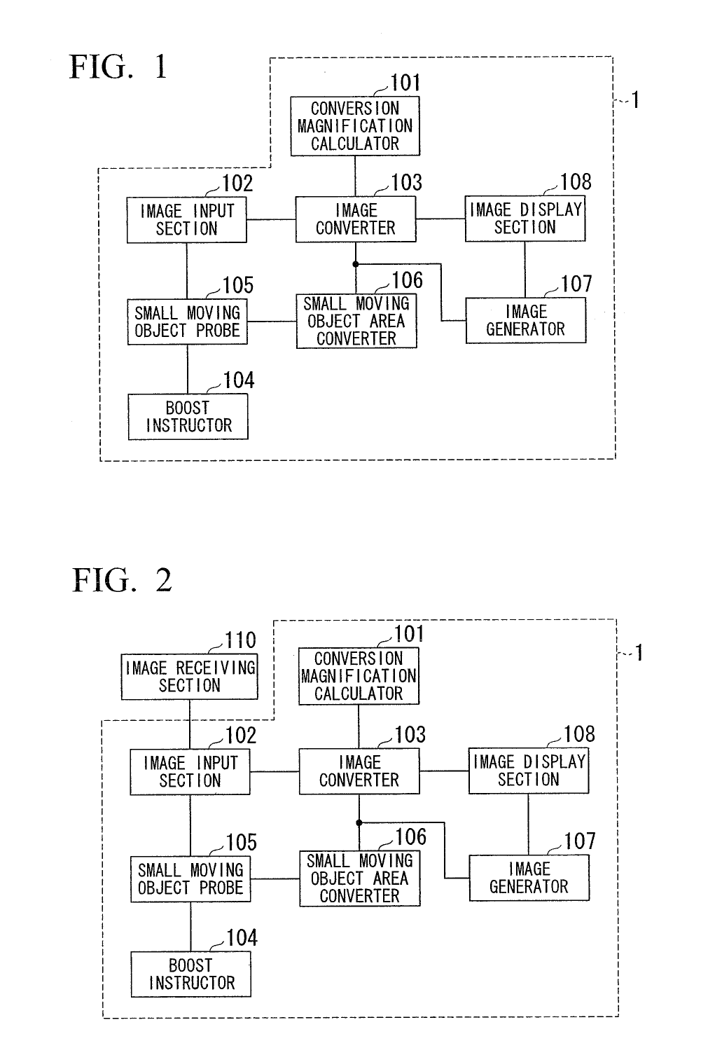

Below, a description will be given of a first embodiment of the present invention with reference to the accompanying drawings. FIG. 1 is a configuration view showing the structure of an image processing device according to this embodiment. The image processing device 1 includes a conversion magnification calculator 101, an image input section 102, an image converter 103, a boost instructor (i.e., magnification requester) 104, a small moving object probe 105, a small moving object area converter 106, an image generator 107, and an image display section 108.

The conversion magnification calculator 101 calculates a conversion magnification, at which an input image, the input of which is received by the image input section 102, is magnified or reduced when the input image is converted into a display image to be displayed, based on the resolution of the input image and the number of pixels of a display screen. The image input section 102 receives the input of the input image. The image converter 103 converts the input image into the display image by magnifying/reducing the input image based on the conversion magnification calculated by the conversion magnification calculator 101. The boost instructor 104 has a button (i.e., boost displaying button), and through the boost displaying button, receives a command to magnify the area of a small moving object from the user. The small moving object is a small object, which is moving, such as a tennis ball or a golf ball. The small moving object probe 105 searches the image area of the small moving object (i.e., small moving object area) in the input image. The small moving object area converter 106 clips the small moving object area, which is detected by the small moving object probe 105, from the input image, and magnifies it. The image generator 107 generates an overlap image by overlapping the small moving object area magnified by the small moving object area converter 106 over the display image converted by the image converter 103. The image display section 108 outputs the overlap image, generated by the image generator 107, on the display screen.

In addition, the image processing device 1 of this embodiment is used for a TV set, a video camera, or the like.

FIG. 2 is a configuration view showing the structure of a TV set using the image processing device according to this embodiment. The TV set includes an image receiving section 110 and the image processing device 1. The image receiving section 110 receives an image on a TV broadcasting radio wave. The image input section 102 of the image processing device 1 receives the input of the image received by the image receiving section 110. Except for this operation, the other operations are the same as in the above description.

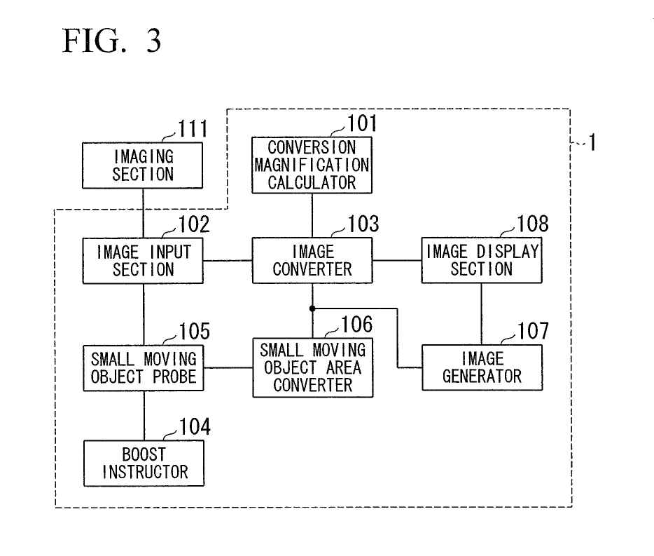

FIG. 3 is a configuration view showing the structure of a video camera using the image processing device according to this embodiment. The video camera includes an imaging section 111 and the image processing device 1. The imaging section 111 captures an image. The image input section 102 of the image processing device 1 receives the input of the image captured by the imaging section 111. Except for this operation, the other operations are the same as in the above description.

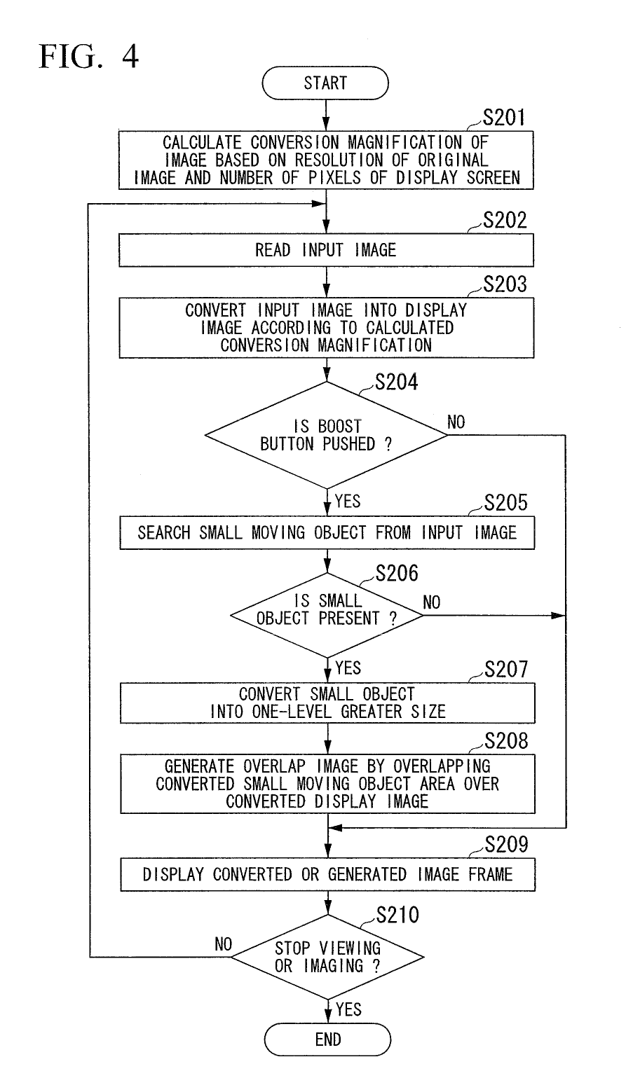

Next, a description will be given of the flow of a process by properly referring to FIG. 4. FIG. 4 is a view showing the flow of a process according to this embodiment. First, the conversion magnification calculator 101 calculates a conversion magnification, at which an input image, the input of which is received by the image input section 102, is magnified or reduced (step S201). The conversion magnification is calculated based on the resolution of the input image, the size of a display screen, and the number of pixels of the display screen. Then, the process proceeds to step S202. The method for calculating the conversion magnification is the same as the method for displaying an image on a display screen, which is conventionally performed. In step S202, the small moving object probe 105 reads the input image, and then the process proceeds to step S203. In step 203, the image converter 103 converts the input image read in step S202 into a display image based on the conversion magnification calculated in step S201, and then the process proceeds to step S204. In step S204, the boost instructor 104 determines whether the boost displaying button is pushed or not. If it is determined that the boost displaying button is pushed, the process proceeds to step S205. If it is determined that the boost displaying button is not pushed, the process proceeds to step S209.

In step S205, the small moving object probe 105 searches a small moving object area in the input image, and the process proceeds to step S206. In step S206, the small moving object probe 105 determines whether a small moving object is found or not. If it is determined that the small moving object is found, the process proceeds to step S207. If it is determined that the small moving object is not found, the process proceeds to step S209. In step S207, the small moving object area converter 106 clips the small moving object area, which is detected by the small moving object probe 105, from the input image, and magnifies it to a one-level greater size, and then the process proceeds to step S208. The one-level greater size indicates, for example, a size that is 10% magnified from a previous size prior to the magnification. In step S208, an overlap image is generated by overlapping the input image magnified in step S207 over the small moving object area of the display image converted in step S203. Then, the process proceeds to step S209.

In step S209, the overlap image or the display image is displayed, and then the process proceeds to steps S210. If an overlap image is present, the overlap image is displayed. If no overlap image is present, the display image is displayed. If viewing or imaging is continued in step S210, the process returns to step S202. If stopped, the process ends.

As described above, this embodiment can improve the visibility of a small moving object, for example, a ball in an image of sports, such as baseball, tennis, golf, or the like, or a shooting star in an astronomical observation since it can generate an overlap image by identifying the small moving object, relatively magnifying only the small moving object area, and overlapping the magnified small moving object area over the original image while maintaining the entire display range of the image.

### Second Embodiment

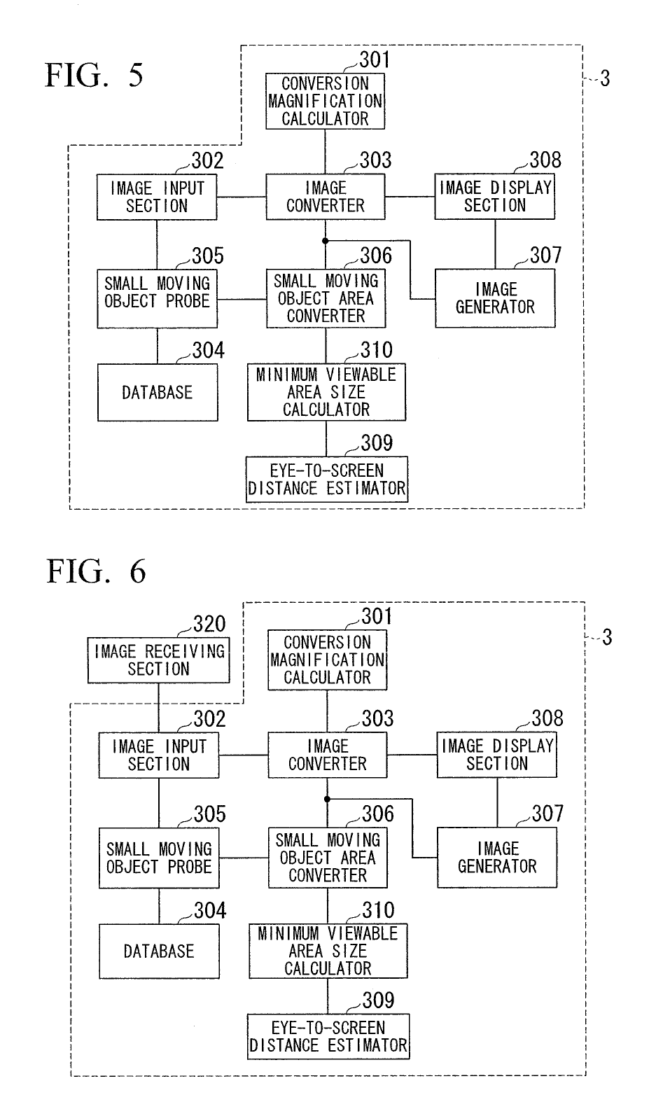

Next, a description will be given of a second embodiment of the present invention with reference to the accompanying drawings. FIG. 5 is a configuration view showing the structure of an image processing device according to the second embodiment of the present invention. The image processing device 3 includes a conversion magnification calculator 301, an image input section 302, an image converter 303, a database 304, a small moving object probe 305, a small moving object area converter 306, an image generator 307, an image display section 308, an eye-to-screen distance estimator (i.e., viewing distance estimator) 309, and a minimum viewable area size calculator (i.e., minimum size calculator) 310.

The conversion magnification calculator 301, the image input section 302, the image converter 303, the small moving object probe 305, the small moving object area converter 306, the image generator 307, and the image display section 308 are the same as those of the first embodiment. The database 304 stores information on a small moving object. The eye-to-screen distance estimator 309 estimates the distance between the eye of an observer (e.g., a TV viewer or a photographer) and the screen. The minimum viewable area size calculator 310 calculates the size of a viewable area using a conventional technology, based on the size of the display screen, the number of pixels of the display screen, or the distance estimated by the eye-to-screen distance estimator 309.

Herein, an example of the method for calculating the minimum size of the viewable area by the minimum viewable area size calculator 310 will be described. The minimum size of the viewable area can be calculated by the following formulas:

1/C≦60×57.3×P×S/D

that is,

S≧D/(C×P×60×57.3)

In the above formulas, P is the pitch of pixels, D is the distance between the screen and the eye of an observer, C is the eyesight of the observer, and S is the minimum size of the viewable area.

In addition, the image processing device 3 of this embodiment is used for a TV set, a video camera, or the like.

FIG. 6 is a configuration view showing the structure of a TV set using the image processing device 3 according to this embodiment. The TV set includes an image receiving section 320 and the image processing device 3. The image receiving section 320 receives an image on a TV broadcasting radio wave. The image input section 302 of the image processing device 3 receives the input of the image received by the image receiving section 320. Except for this operation, the other operations are the same as in the above description.

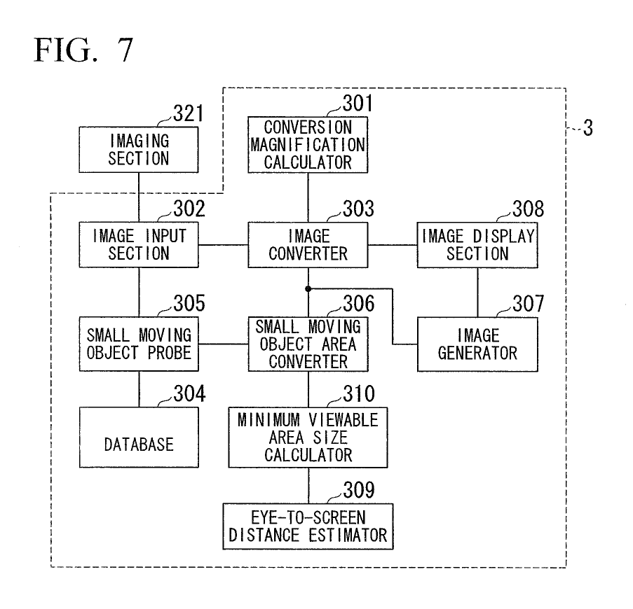

FIG. 7 is a configuration view showing the structure of a video camera using the image processing device 3 according to this embodiment. The video camera includes an imaging section 321 and the image processing device 3. The imaging section 321 captures an image. The image input section 302 of the image processing device 3 receives the input of the image captured by the imaging section 321. Except for this operation, the other operations are the same as in the above description.

Below, several specific numerical values, calculated using the above formulas, will be illustrated by way of examples. In these examples, the eyesight of the observer is assumed to 0.5.

In an example of liquid crystal for a mobile application, if the pitch of pixels P is 0.126 mm and the distance between the screen and the eye of the observer D is 400 mm, S is equal to or greater than 1.84. Accordingly, the size S of the viewable area is 2×2.

In an example of TFT liquid crystal for a PC, if the pitch of pixels P is 0.264 mm and the distance between the screen and the eye of the observer D is 800 mm, S is equal to or greater than 1.76. Accordingly, the size S of the viewable area is 2×2.

In a 32-type liquid crystal TV, if the pitch of pixels P is 0.51 mm and the distance between the screen and the eye of the observer D is 2400 mm, S is equal to or greater than 2.79. Accordingly, the size S of the viewable area is 3×3.

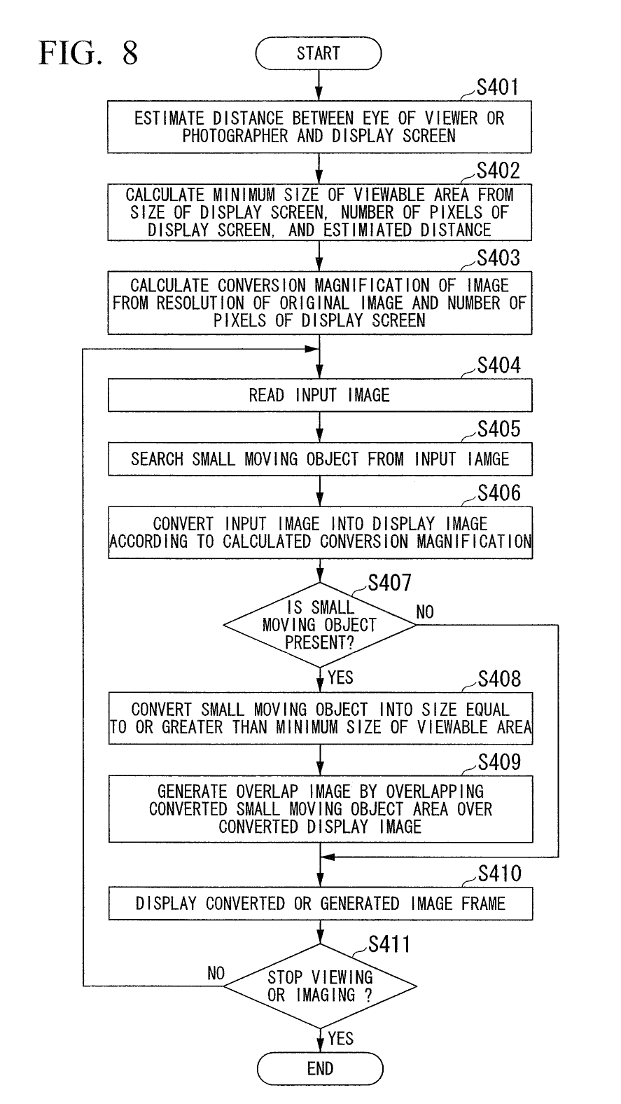

Next, a description will be given of the flow of a process by properly referring to FIG. 8. FIG. 8 is a view showing the flow of a process according to the second embodiment. First, the eye-to-screen distance estimator 309 estimates the distance between the eye of the observer and the display screen (step S401), and then the process proceeds to step S402. For example, the estimation method may be a method for measuring the distance between a remote controller, which is equipped with a distance-measuring IR transceiver, and a display screen. In step S402, the minimum viewable area size calculator 310 calculates the minimum size of a viewable area, based on the distance between the eye of the observer and the display screen estimated in step S401, the size of the display screen, and the number of pixels of the display screen. Then, the process proceeds to step S403. The calculation method is the same as the above description. Processing after step S403 is the same as in those in the first embodiment. However, in step S408 of converting the small moving object into a size equal to or greater than the minimum size of the viewable area, the small moving object is magnified based on the minimum size of the viewable area calculated in step S402. For example, if the size of the small moving area is 1×1 and the minimum size is 3×3, the small moving object area converter 306 converts the small moving object into a size 3×3.

As described above, this embodiment makes it possible to estimate the distance between the eye of the observer and the display screen, calculate the minimum size of the area that is recognizable to the observer, and magnify only the small moving object area to be greater than the minimum size of the calculated recognizable area.

When the small moving object probe 305 searches the small moving object, information, which is stored in the database 304 in advance, may be used for the search. For example, the database 304 may store the name of a ball game and the color and shape of a ball used in the ball game in advance. The image input section 301 may receive, together with the input of an image, information indicating that the input image is tennis based on the title of a broadcast program or a clearly-stated designation. Subsequently, the small moving object probe 305 may acquire the “yellow ball” information, i.e., information on the small moving object in the case of tennis from the database 304, and search the small moving object using the “yellow ball” information as a guide.

In addition, the present invention may be used as a video camera, a digital camera, or a portable camera by having a structure in which an imaging section is additionally provided, the image input section 302 receives the input of an image captured by the imaging section, and the image display section 308 outputs the image to a monitor that displays the imaged object. For example, when a scene of a ball game is imaged, a photographer can identify both the entire scene and the magnified ball, by identifying the image output from the image display section on a liquid crystal finder or a liquid crystal monitor. This makes it easy to identify the motion of the ball since the magnified image of the ball is projected on the liquid crystal finder or the liquid crystal monitor.

In addition, instead of being provided with the eye-to-screen distance estimator 309, the distance between the eye of an observer and the screen may be previously set to a fixed value. For example, in the case of a portable device, the distance between the eye of the observer and the screen may be set to 30 cm to 50 cm due to the fact that the portable device is generally used while held by hand.

While the embodiments of the present have been described in detail with reference to the accompanying drawings, the detailed constitutions of the present invention are by no means limited to the foregoing embodiments but embrace changes in design to the extent that they do not depart from the concept of the present invention.

According to the present invention, it is possible to improve the visibility of an image while maintaining the display range of the entire image by identifying a small moving object displayed in the image, magnifying the small moving object and displaying it.

What is claimed is:

1. An image processing device comprising:
an image input section which receives an input of an image;
an image converter which generates a converted image by magnifying or reducing the image, the input of which is received by the image input section, based on a predetermined conversion magnification;
a small moving object probe which specifies a small moving object area in the image, the input of which is received by the image input section, the small moving object area being an image area including a small moving object;
a small moving object area converter which generates a magnified image of the small moving object by magnifying the small moving object area, which is specified by the small moving object probe; and
an image generator which generates a synthetic image by synthesizing the magnified image of the small moving object generated by the small moving object area converter with the converted image generated by the image converter.

2. The image processing device according to claim 1, further comprising
a magnification requester which receives a magnification request to magnify the small moving object area,
wherein the small moving object probe searches the small moving object area when the magnification requester receives the magnification request.

3. The image processing device according to claim 1, further comprising:
an image display section which displays the synthetic image generated by the image generator on a display screen; and
a minimum size calculator which calculates a magnification of the small moving object area based on the size of the display screen and the number of pixels of the display screen,
wherein the small moving object area converter generates the magnified small moving image based on the magnification calculated by the minimum size converter.

4. The image processing device according to claim 3, further comprising
a viewing distance estimator which estimates a viewing distance as a distance between an eye of an observer and the display screen,
wherein the minimum size calculator calculates the magnification of the small moving object area based on the viewing distance estimated by the viewing distance estimator.

5. The image processing device according to claim 1, further comprising
an imaging section which captures the image,
wherein the image input section receives the input of the image captured by the imaging section.

6. The image processing device according to claim 1, further comprising
a database which stores information on the small moving object,
wherein the small moving object probe specifies the small moving object area based on the information stored in the database.

7. A program that controls an operation of an image processing device, the program causing the image processing device to execute:
a step of receiving an input of an image;
a step of generating a converted image by magnifying or reducing the image based on a predetermined conversion magnification;
a step of specifying a small moving object area in the image, the small moving object area being an image area including a small moving object;
a step of generating a magnified image of the small moving object by magnifying the specified small moving object area; and
a step of generating a synthetic image by synthesizing the magnified image of the small moving object with the converted image.

8. A recording medium that records a program that controls an operation of an image processing device, the program causing the image processing device to execute:
a step of receiving an input of an image;
a step of generating a converted image by magnifying or reducing the image based on a predetermined conversion magnification;
a step of specifying a small moving object area in the image, the small moving object area being an image area including a small moving object;
a step of generating a magnified image of the small moving object by magnifying the specified small moving object area; and
a step of generating a synthetic image by synthesizing the magnified image of the small moving object with the converted image.
